(19) United States
(12) Patent Application Publication
(10) Pub. No.: US 2015/0216312 A1
(43) Pub. Date: Aug. 6, 2015

(54) STADIUM SEAT SUPPORT ASSEMBLY

(71) Applicant: Daniel Sprinkle, Rushville, IN (US)

(72) Inventor: Daniel Sprinkle, Rushville, IN (US)

(21) Appl. No.: 14/606,099

(22) Filed: Jan. 27, 2015

Related U.S. Application Data
(60) Provisional application No. 61/936,515, filed on Feb. 6, 2014.

(51) Int. Cl. A47C 7/00; G09F 23/00; A47C 1/12

(52) U.S. Cl. CPC A47C 7/002; A47C 1/12; G09F 23/00; G09F 2023/005

(57) ABSTRACT

An assembly for converting a recovered racetrack stadium seat to a freestanding chair, including a generally crescent- or C-shaped side mounting frame having a first elongated member, a second spaced elongated member substantially parallel to the first elongated member, and a third elongated member connected between the first and second elongated members, and a seat attachment assembly, further including at least two elongated attachment members for engaging at least one support members connected beneath the seat and a plurality of fasteners for connecting the attachment members to the generally C-shaped side mounting frame and securing the at least one support member therebetween.

### CROSS-REFERENCE TO RELATED APPLICATIONS

This application claims priority to co-pending U.S. provisional patent application Ser. No. 61/936,515, filed Feb. 6, 2014.

### BACKGROUND

Over time, the collection of sports memorabilia has grown from a childhood hobby into a multi-billion dollar industry. Stadium seats that were once part of famous arenas around the country, such as the original BUSCH STADIUM (BUSCH STADIUM is registered trademark #2050640 of Anheuser-Busch, Incorporated, a Missouri corporation, located as One Busch Place, St. Louis, Mo. 63118) (colloquially and hereinafter known as Old Busch Stadium) or the recently renovated DAYTONA INTERNATIONAL SPEEDWAY (DAYTONA INTERNATIONAL SPEEDWAY is registered trademark #0986222 of the International Speedway Corporation, a Florida corporation, located at One Daytona Boulevard, Daytona Beach, Fla. 32114), are now highly sought after sports memorabilia by sports enthusiasts and/or collectors that wish to own a piece of sports history. Typically, while in use stadium seats are mounted directly onto the rise of the step or bleacher behind the seat through a vertical bracket or are mounted directly onto a horizontal surface, such as by bolting the two spaced apart vertically extending up-stands to the concrete step floor. When removed from a stadium or sports arena, a stadium seat is typically not able to stand on its own as there is no base or stand affixed to the chairs themselves. In other words, most stadium seats only have two legs or no legs at all. See FIG. 1-4. Currently, individuals are not able to use stadium seats previously utilized in sports arenas as free standing seats or chairs without the use of a pair of ski-like stabilizing base members mounted to each respective leg. While effective in minimizing side-to-side rocking and providing a minimal modicum of stability to the seats, these ski-like mounting ‘feet’ still allow a degree of front-to-back rocking and do little to enhance the appearance of the seats or to compliment the sports experience.

When NASCAR ((NASCAR is registered trademark #1908112 of the National Association for Stock Car Auto Racing, Inc., a Florida corporation, located at One Daytona Boulevard, Daytona Beach, Fla. 32114), hereinafter ‘NASCAR’) tracks are torn down or renovated, fans rally at the opportunity to acquire actual seating from NASCAR tracks for convection and private use, just like football and baseball fans have done in the past. This is especially true for NASCAR, since speedway renovations are very rarely done, making speedway seats ultra-rare. However, NASCAR seats are so different from actual pre-designed stadium seats, as they are essentially legless folding chairs with angle irons welded onto their bottom portions for engaging bleacher plans. Accordingly, there is currently no good mechanism for utilizing the NASCAR seats in private seating. Thus, there is a need for an improved stabilizing base for retired stadium seats that has an extended surface area and which increases marketing value through the use of customization and personalization. The present novel technology addresses this need.

### BRIEF DESCRIPTION OF THE DRAWINGS

FIG. 1 is a view of mounted angle irons used in the PRIOR ART to engage a NASCAR stadium seat to the bleacher planks.

FIG. 2 is a view of a PRIOR ART NASCAR stadium seat as disengaged from the bleacher planks.

FIG. 3 is a view of PRIOR ART stadium seating before the renovation of the stadium.

FIG. 4 is a view of PRIOR ART leveled stadium seats.

FIG. 5 is a right side perspective of the right leg of the seat support assembly disassembled, according to the first embodiment of the present novel technology.

FIG. 6 is a left side perspective of the left leg of the seat support assembly disassembled, according to the first embodiment of the present novel technology.

FIG. 7 is a bottom perspective view of the support member of the seat support assembly, according to the first embodiment of the present novel technology.

FIG. 8 is a front perspective view of the frames used in the seat assembly, according to the first embodiment of the present novel technology.

FIG. 9 is a left side perspective view of the legs of the seat assembly according to the first embodiment of the present novel technology.

FIG. 10 a left side perspective view of the legs with the seat of the seat assembly according to the first embodiment of the present novel technology.

FIG. 11 is a front view of the bottom of the seat where the seat is connected to the legs, according to the first embodiment of the present novel technology.

FIG. 12 is a closer left side view of the seat connected to the legs of the seat assembly, according to the first embodiment of the present novel technology.

FIG. 13 is a closer left, bottom side view of the seat connected to the legs of the seat assembly, according to the first embodiment of the present novel technology.

FIG. 14 is a left side perspective of the left leg of the seat support assembly disassembled, according to the second embodiment of the present novel technology.

FIG. 15 is a right side perspective of the right leg of the seat support assembly disassembled, according to the second embodiment of the present novel technology.

FIG. 16 is a closer left, back side view of the seat connected to the legs of the seat assembly, according to the second embodiment of the present novel technology.

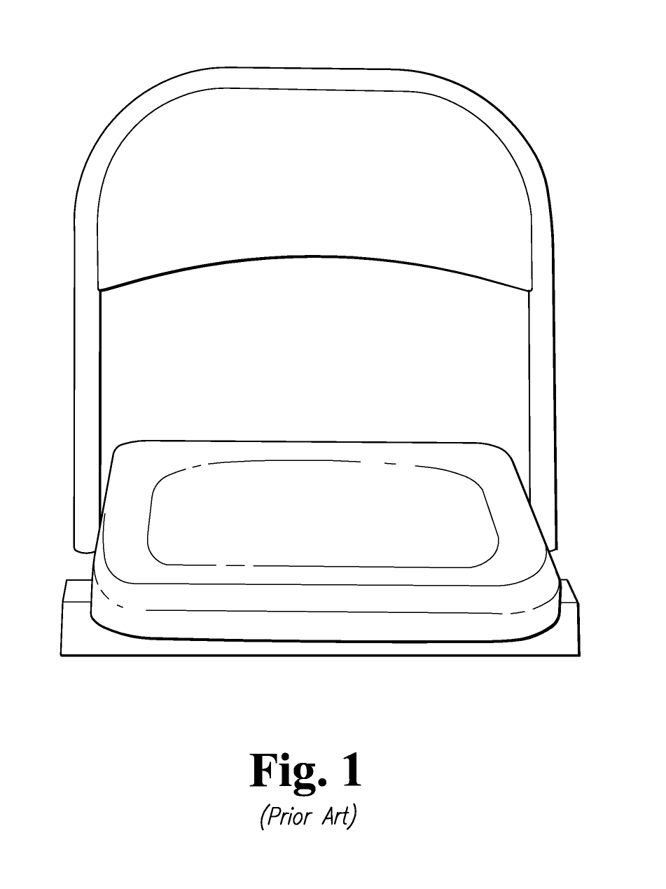

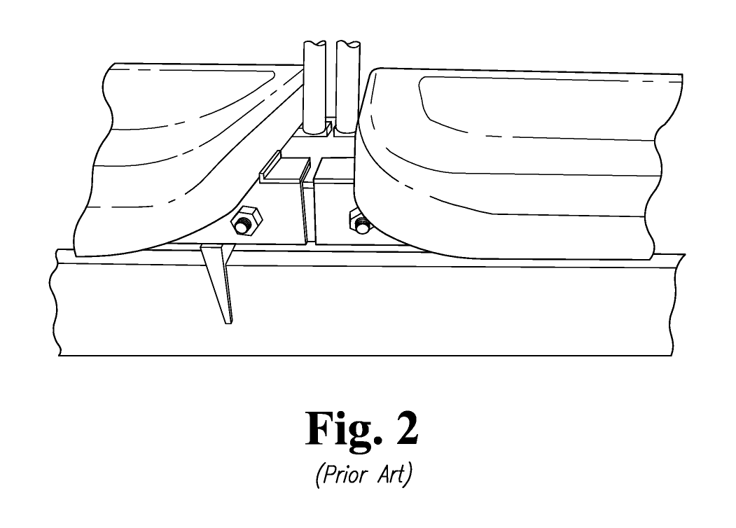

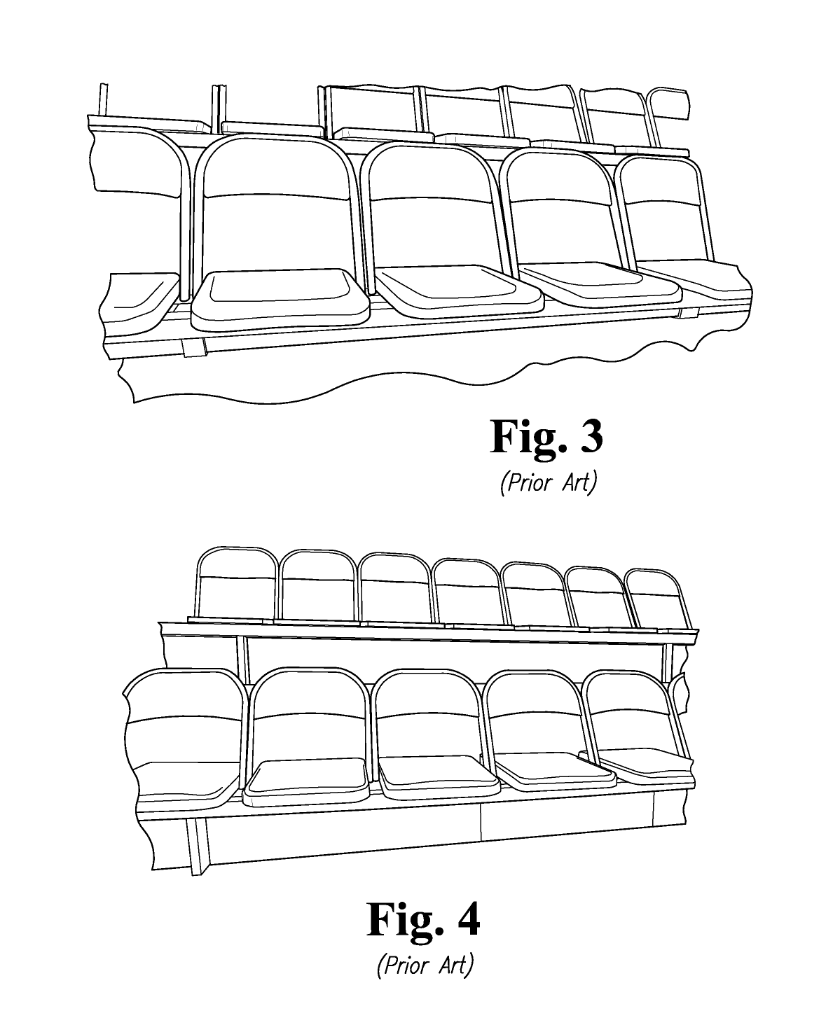

### DETAILED DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

To provide increased stability of, and to enhance sales for, stadium memorabilia seats the present novel technology relates to a system 5 for stabilizing and supporting NASCAR-style recovered legless folding stadium seats 45. The system 5 converts a piece of sports memorabilia (in particular a NASCAR-style stadium seat 45 as retired from service and recovered) that would be inoperable outside of a sports arena into a useful memorabilia article, such as a chair, that can be used outside of a stadium. In addition, the system 5 enhances the appearance of retired stadium seats 45 before adding to the sport memorabilia aspect of the stadium seat while also providing sufficient stabilization to allow the seat 45 to be freestanding.

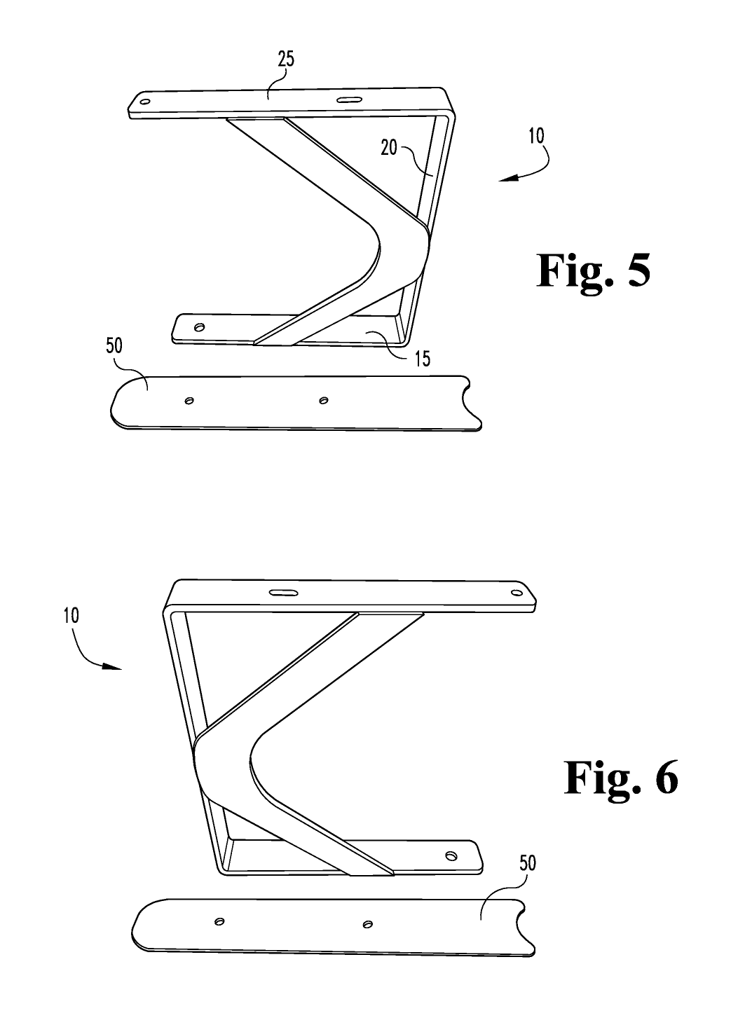

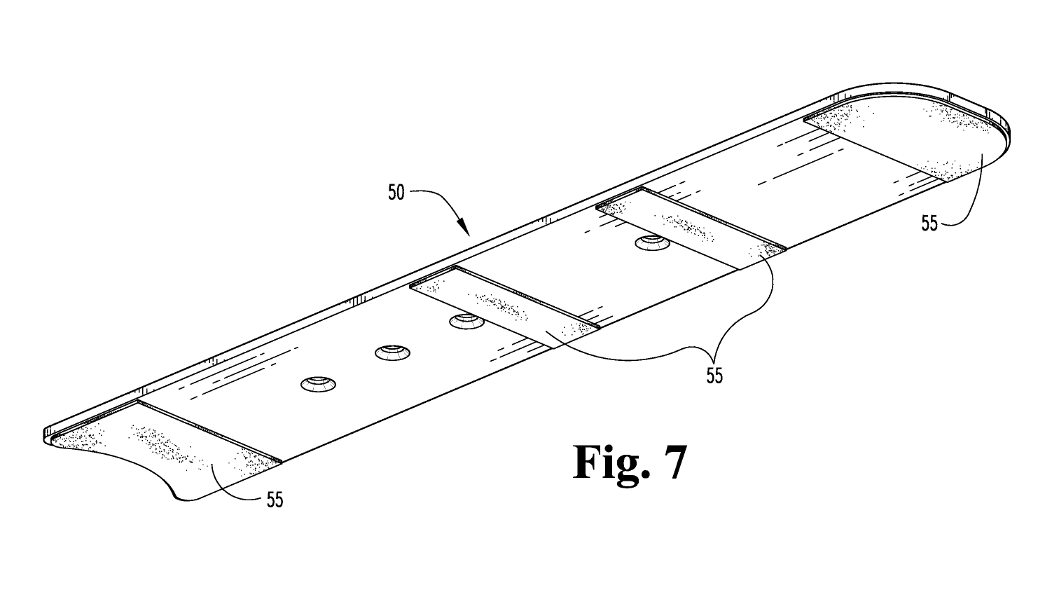

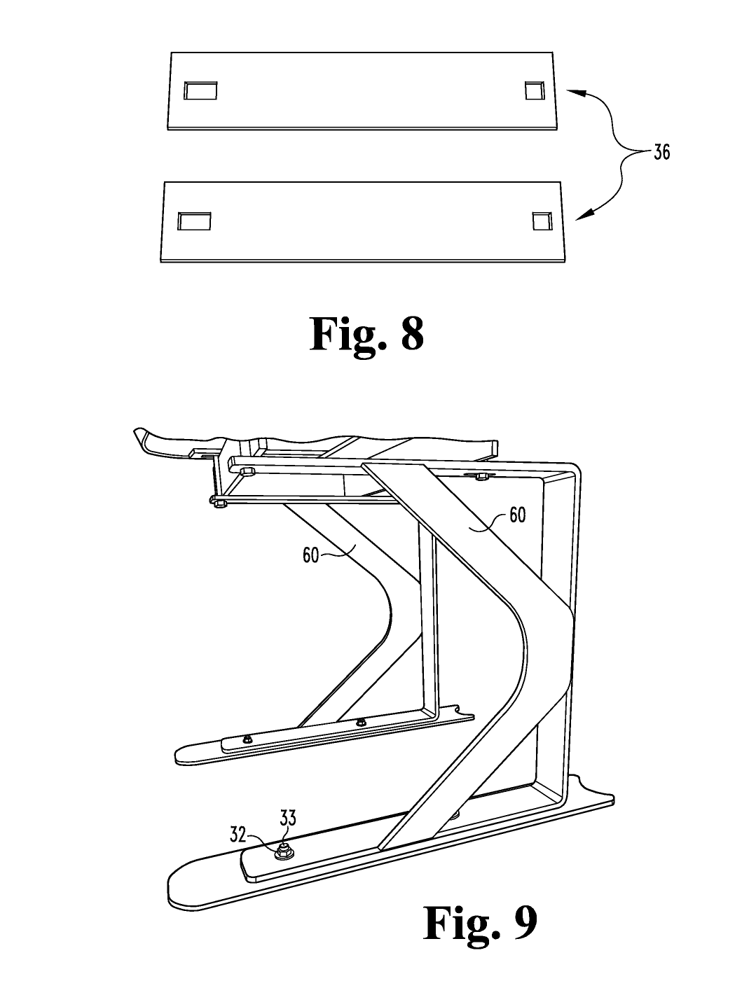

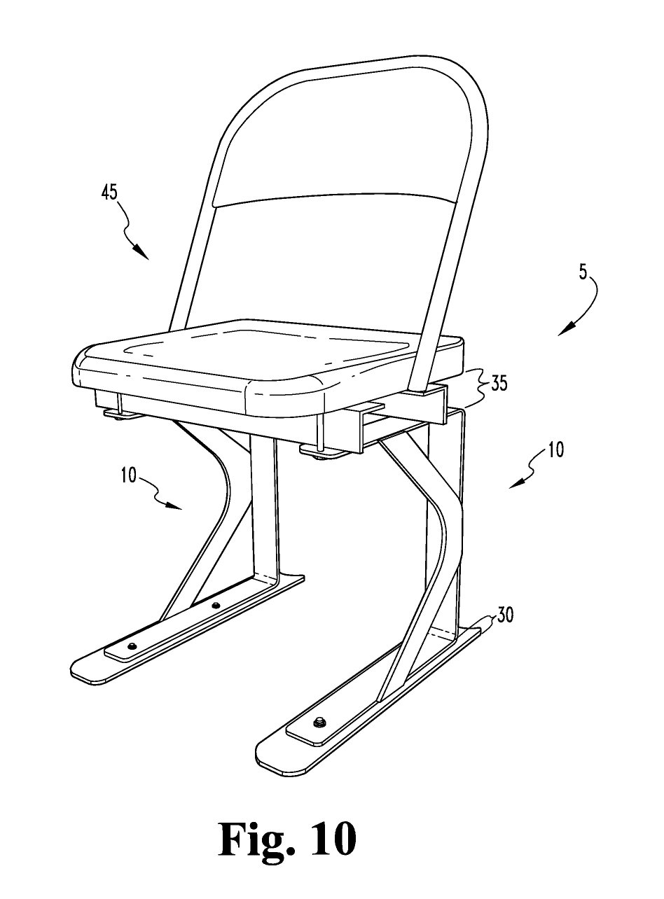

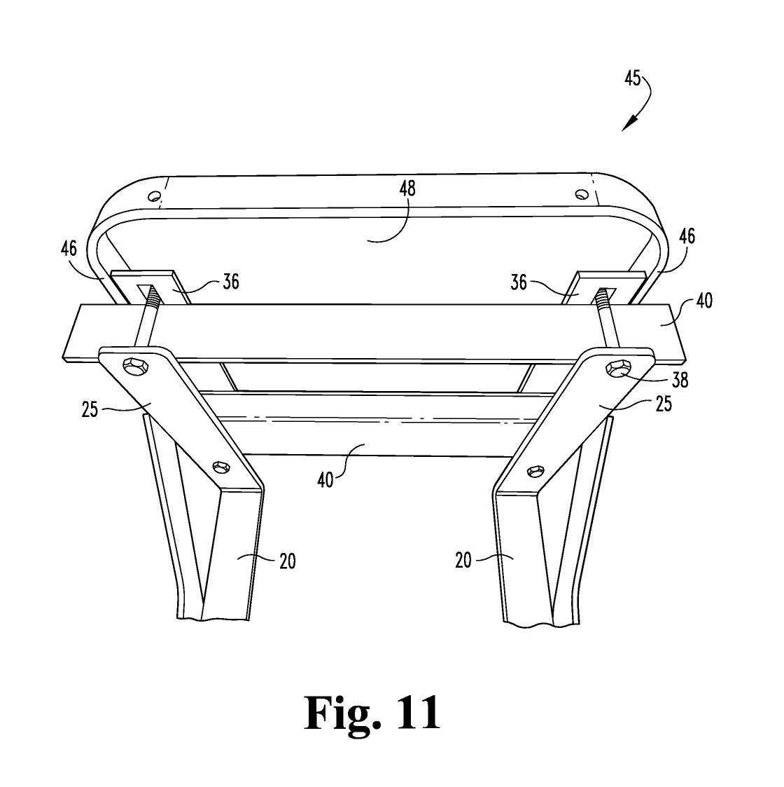

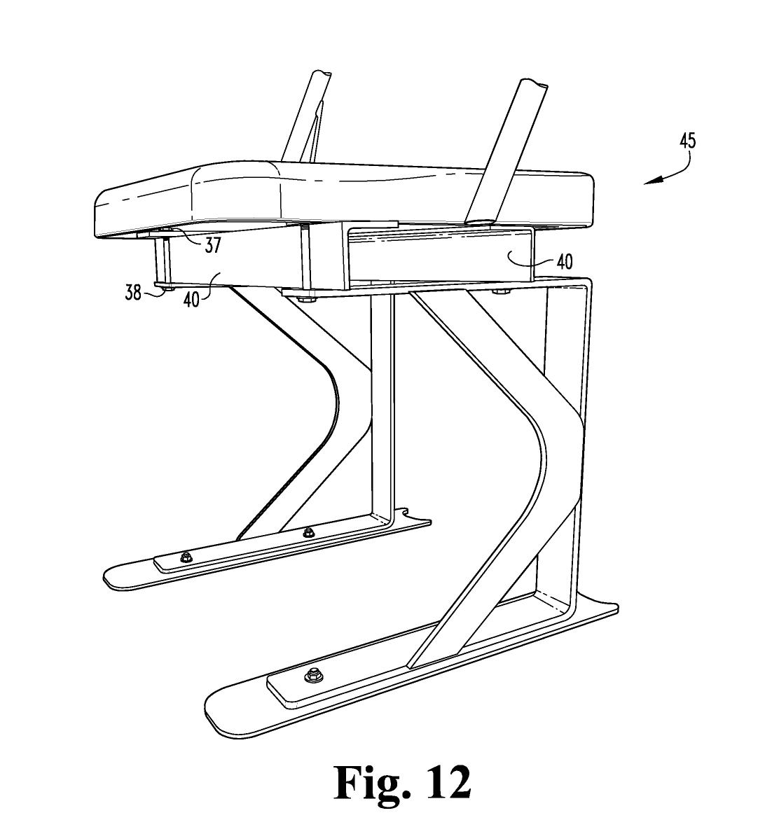

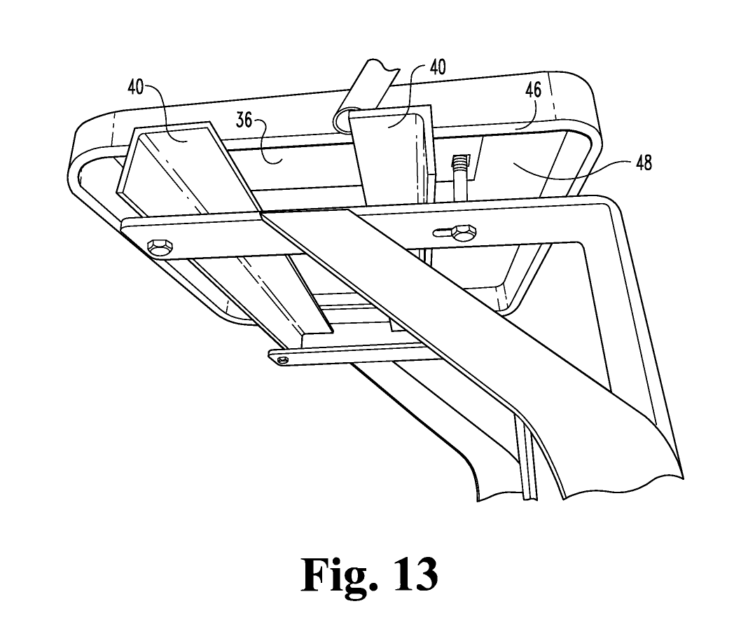

One embodiment of the present novel technology, as shown in FIGS. 5-13, is a seat assembly 5 including two side mounting frames 10, typically originating parallel to each other, and positioned for supporting a seat 45 connected atop the side mounting frames 10. Mounting frames 10 are more typically able to support a seat 45 connected thereto and an occupant for extended periods of time. For example, the seat 45 may support an average human bodyweight, by example and not limited to, one half-hour, one hour, three hours, and/or any other extended period of time without losing structural integrity. In some implementations, the seat 45 may additionally support up to and/or over an average human bodyweight by, but not limited to, several hundred pounds. Each side mounting frame 10 typically include a bottom portion or member 15, a middle portion or member 20, and a top portion or member 25. The bottom portion 25 is typically connected to a floor-engaging portion or member 30, although in some embodiments the bottom portion 25 is also the floor-engaging portion 30. The top portion 15 is connected to the middle or second portion 20, which in turn extends between the first and third portions 15, 25 to define a generally U-shaped mounting frame 10. The seat 45 is engageable to the third portion 25 of the side mounting frame 10. Typically, the first and third portions 15, 25 each intersect the second piece 20 at angles close to ninety (90) degrees. Typically, the portions 15, 20, 25 are elongated substantially linear members but they may also have curved or nonlinear shapes. Each respective side mounting frame 10 is typically positioned on an opposite side of the chair 45, but the orientation of the respective frames 10 may also be rotated ninety (90) degrees such that respective frames 10 are positioned below the front and back portions of the chair 45. In some implementations, a utility piece 60 may be connected between top portion 25 and bottom portion 15, and optionally to middle portion 20 as well, to provide additional structural integrity to assembly 5. The utility piece 60, as shown in FIG. 9, may be a boomerang-like shape; however, it may be of any shape and may typically be made of the same steel or structural substance as the side mounting frame 10.

The chair 45 typically includes an assembly for engaging the chair 45 to the bleacher planks. When the chair 45 is removed from a bleacher plank, the chair 45 typically includes a pair of chair support members 40 (e.g., angle irons), each attached to the lip 46 of the bottom 48 of the chair 45, to define a volume for engaging a plank. Each respective chair support member 40 spaced apart extends from the lip 46 of the chair 45 across the bottom 48 of the chair 45 to define a flange for the chair 45 to grippingly engage a bleacher plank. There is typically an empty volume between the chair bottom 48 and the chair support members 40 except for at the lip 46.

A chair attaching assembly 35 is typically positioned above the top portion 25 of the side mounting frame 10, or may be the top portion 25 of the side mounting frame 10. The chair attaching assembly 35 may include one or more (typically two) elongated attachment members 36 disposed between the bottom 48 of the chair 45 and the top of the chair support members 40, having one or more apertures therethrough for engaging a plurality of fasteners with the top portion 25. The chair attaching assembly 35 typically includes two holes in each top portion 25 and elongated attachment member 36 to fasten (such as with nuts 37 and bolts 38) the side mounting piece 10 to the chair 45. Likewise, a floor attaching assembly 30 positioned below the first side 15 also is typically elongated and rectangular in shape, with holes formed there through for fasteners 32, 33 to extend through (typically nuts 32 and bolts 33) the side mounting frame 10 (typically via the bottom portion 15) into a support member 50. The support member 50 is typically longer and wider than the first portion 15 of the side mounting frames 10 in order to increase the balance and stability of the chair 5 when in the freestanding position. The support member 50 typically includes rubber or like pads 55 thereto for engaging the floor, for added comfort, height and durability. The system 5 may still operate without the inclusion of the support bottom 50 and/or the rubber pads 55 connected to the support bottom 50 and instead simply have the bottom portion 15 of the side mounting frame 10 directly engage the floor with or without rubber pads 55 connected thereto.

The seat assembly 5 is typically made out of wood or metal, although any convenient structural material may be selected, and is of sufficient surface area to stabilize and support the weight of the stadium seat 15 with the addition of body weight thereon. Typically, the assembly 5 is made of ¼″, ⅛″, 3/16″ thick, or the like, steel. Generally, the seat assembly 5 typically spans no more than about 30% of the surface area under a stadium seat 45, more typically no more than about 25% of the surface area under a stadium seat 45, and still more typically no more than about 15% or less of the surface area under a stadium seat 45 with the remainder of the surface area under the seat 45 being open or free. The span of the seat assembly 5 and, more specifically, the mounting frames 10, underneath the stadium seat 45 provides for greater surface area stabilization compared to conventional methods for chair support. Additionally, stadium seats 45 are not inherently well balanced, as they are designed to be bolted down in normal use. Independent balance and support are not important stadium seat 45 design considerations since the seats are normally not designed to be free standing. By design, NASCAR-style stadium seats 45 commonly do not have legs or the like extending therefrom and (the chair support members 40) have at most two areas of contact with their support surface and cannot stand above ground on their own. Without a stabilizing seat assembly 5 extending from the chair 45 to the ground and that covers a sufficient area under the stadium seat 45, a stadium seat 45 cannot stand alone.

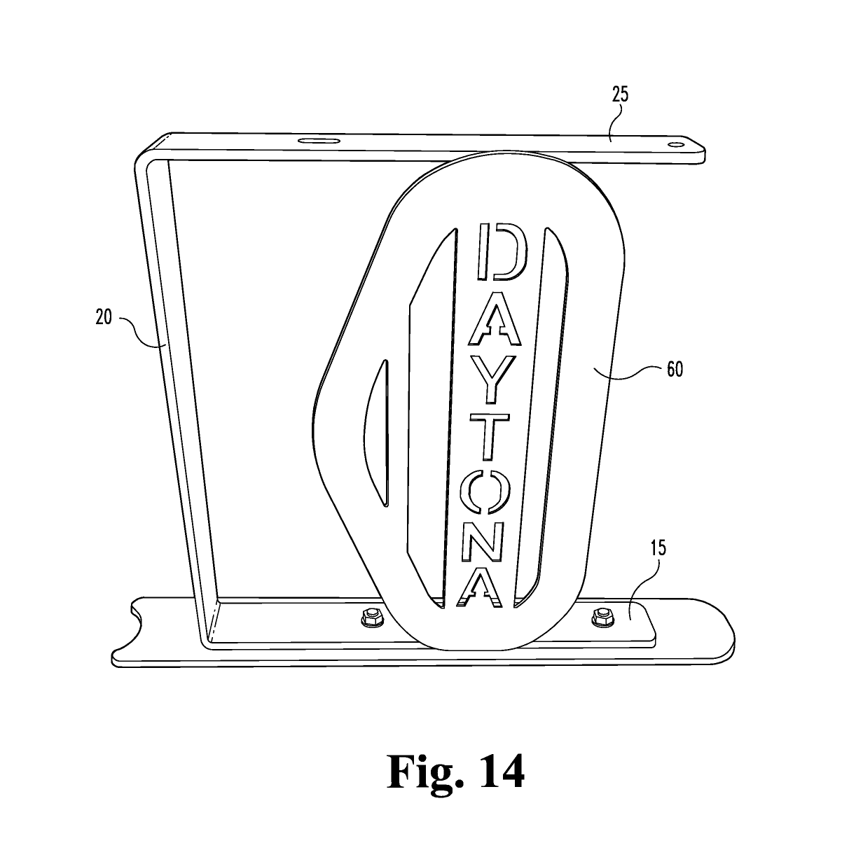

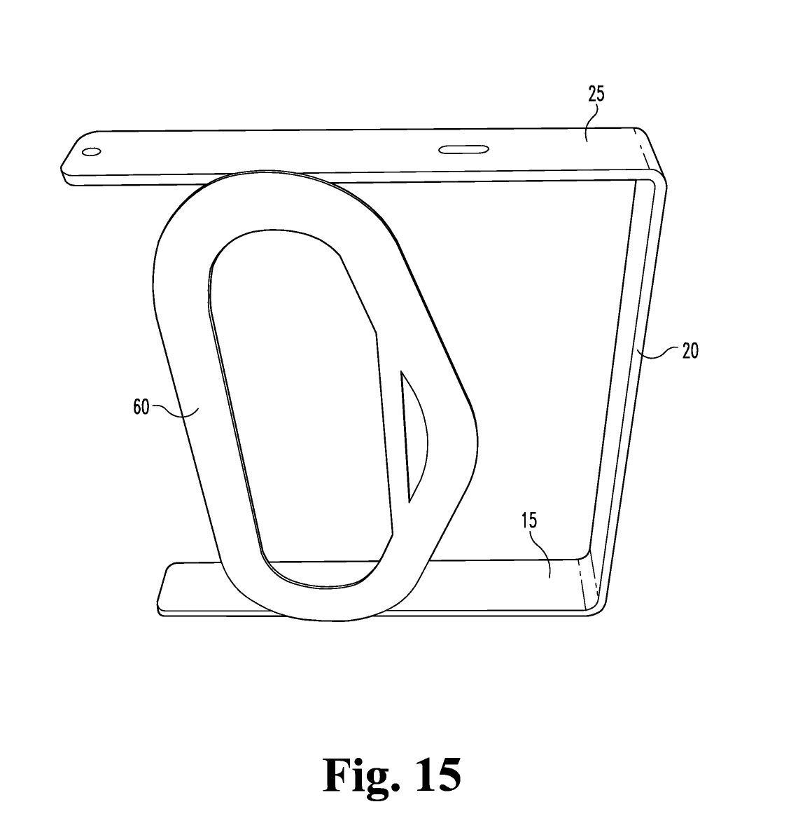

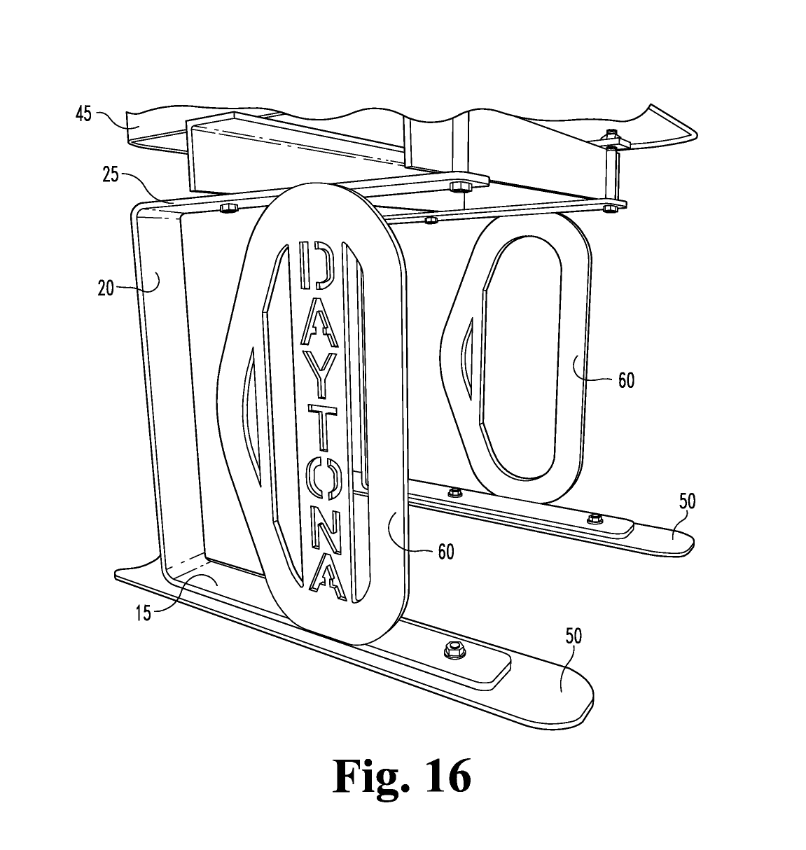

FIGS. 14-16 depict a second embodiment of the present novel invention that differs from the first embodiment by the inclusion of additional area to include text or images on the utility piece 60, typically extending between the first and third portions 15,25. The utility piece 60 is connected to the side mounting frame 10 and may include configurations that include text and/or logos in furtherance to support the event or entity for which the seat is used or any other text desired. The utility piece 60 is generally shaped to resemble an article of sports memorabilia and/or equipment, such as the outline, shape, or silhouette of a sports figure and/or icon (such as the DAYTONA 500(DAYTONA 500 is registered trademark #0964900 of the International Speedway Corporation, a Florida corporation, located at One Daytona Boulevard, Daytona Beach, Fla. 32114) logo shown in FIGS. 14, 16), the outline, shape, or silhouette of automobile racing cars, tracks (e.g., as shown in FIG. 15), team or track logos, or racing equipment. The configuration may also be in the general shape of a boomerang (e.g., as described and shown above with respect to FIGS. 5-13) and may typically be made of the same steel or structural substance as the side mounting frame 10 and may have text or images carved out of the boomerang shape or any other sides configuration.

The following example is merely representative of the work that contributes to the teaching of the present novel article and is not to be restricted by the following example.

Example of typical dimensions for a typical embodiment of the present novel technology:

The floor attaching assembly 30 on the bottom is 18 ½″ long, 3″ wide, and is made of 3/16 inch thick steel, with rubber pads 55 on the bottom. The side mounting pieces 10 are each 14″ long and 2″ wide and are made of ¼ inch thick steel. The assembly 5 is typically crescent shaped, or, in other words, shaped like a ‘C’ or sideways ‘U’, and the total perimeter length is about 39.75 inches. The chair attaching assembly 35 has a piece that is recessed into the space defined by the skirt extending from the seat, has an elongated rectangular shape and is 10″ long, 2 inches wide, and ¼ inch thick steel. It has one 7/16″ square aperture formed therethrough and one 7/16″×⅞″ rectangular aperture formed through the other end. There are four total 3″ carriage bolts 33/38 and flange nuts 32/37 (both ⅜″) connecting the mounts to the seat.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed:

1. An assembly for converting a recovered stadium seat to a freestanding chair, comprising:
a generally C-shaped side mounting frame having a first elongated member, a second spaced elongated member oriented substantially parallel to the first elongated member, and a third elongated member connected to the first and second elongated members and extending therebetween; and
a seat attachment assembly, further comprising:
at least two elongated attachment members for engaging at least one chair support members connected beneath the seat; and
a plurality of fasteners for connecting the at least two elongaged attachment members to the generally C-shaped side mounting frame and securing the at least one chair support members therebetween.

2. The chair assembly of claim 1, further comprising:
a utility member operationally connectable to the generally C-shaped side mounting frame;
wherein the utility member reinforces the generally C-shaped side mounting frame; and
wherein the utility member displays a decorative design.

3. The chair assembly of claim 1, wherein the side mounting frame is steel.

4. The chair assembly of claim 1, wherein the utility member has a shape selected from the group comprising a sports article, a sports icon, a sports personality, a racecar, a racing logo, a race track, and combinations thereof

5. The chair assembly of claim 1, wherein the utility member is a plurality of utility members.

6. The chair assembly of claim 1, wherein the seat attachment assembly is recessed into a recovered stadium seat.

7. The chair assembly of claim 1, and further comprising:
a floor attachment assembly having an elongated floor-engaging member and at least one fastener;
wherein the floor-engaging elongated member is wider than the second elongated member;
wherein the floor-engaging member is fastened to the second elongated members; and
wherein the floor engaging member engages a floor.

8. The chair assembly of claim 1, wherein the second elongated member is about 14 inches long, about 2 inches wide, and ¼ inch thick steel; and wherein the generally C-shaped side-mounting frame is steel.

9. The chair assembly of claim 1, wherein the floor attachment assembly is about 20 inches long, about 3 inches wide, and is about of 3/16 inch thick.

10. The chair assembly of claim 1, wherein the floor attachment assembly further comprises a rubber pad positioned opposite the second elongated member.

11. A chair assembly of claim 1, wherein the chair assembly engages a floor surface area of about 25% of the surface area under the stadium seat.

12. The chair assembly of claim 1, wherein the chair assembly engages a floor surface area of about 30% of the surface area under the stadium seat.

13. A system for enhancing the marketability of stadium seats harvested from a car racing venue, comprising:
at least one side mounting frame for securely mounting and fastening a retired stadium seat thereto; and
a plurality of bolt holes positioned in the side mounting frames for attaching the retired stadium seat thereto;
wherein the stadium seat defines a first surface area thereunder;
wherein the at least one side mounting frame spans about 25% of the first surface area; and
wherein the at least one side mounting frame includes a portion having a shape evocative of automobile racing.

14. The system of claim 13, wherein the portion having a shape evocative of automobile racing is in the shape of a racecar.

15. The system of claim 13, wherein the portion having a shape evocative of automobile racing is in the shape of a racetrack.

16. A kit for converting a racetrack bleacher-mounted seat having at a flat seat portion and at least one chair support member connected thereacross into a free-standing chair, comprising:
two respective generally C-shaped side mounting frames, wherein each respective generally C-shaped side mounting frame further comprises:
a first elongated member;
a second spaced elongated member oriented substantially parallel to the first elongated member;
a third elongated member connected to the first and second elongated members and extending there between; and
at least two elongated attachment members for engaging the at least one chair support member, wherein each elongated attachment member is connectible to a respective generally C-shaped side mounting frame for engaging the at least one support member therebetween; and
a plurality of fasteners for connecting the elongated attachment member to a respective generally C-shaped side mounting frame.

17. The kit of claim 16, further comprising:
at least two utility members;
wherein each respective utility member is operationally connected to a respective generally C-shaped side mounting frame; and
wherein each respective utility member has a shape evocative of automobile racing.

18. The kit of claim 17 wherein each respective utility member has a shape selected from the group comprising racecars, racetracks, racetrack names, racing team names, racing team logos, racecar driving gear, racecar components, and combinations thereof.
